(19) United States
(12) Patent Application Publication
(10) Pub. No.: US 2019/0380328 A1
(43) Pub. Date: Dec. 19, 2019

(54) INTERACTIVE DEER SCENT DISPLAY APPARATUS AND RELATED METHOD

(71) Applicant: Christopher Jon Strussion, Bellaire, OH (US)

(72) Inventor: Christopher Jon Strussion, Bellaire, OH (US)

(21) Appl. No.: 16/439,080

(22) Filed: Jun. 12, 2019

Related U.S. Application Data
(60) Provisional application No. 62/686,940, filed on Jun. 19, 2018.

(51) Int. Cl. A01M 31/00

(52) U.S. Cl. CPC A01M 31/008

(57) ABSTRACT

An interactive scent display device with a plurality of communicative scent surfaces disposed in an anatomically correct dispersion for attracting deer. A hunter or game observer can easily and quickly emplace place it the device in a desired tree or ground location. The interactive scent display device provides a visual attractant to deer and displays the natural or synthetic gland scents deer use in communication within the herd.

### CROSS-REFERENCE TO RELATED APPLICATIONS

This application is a perfection of Provisional Application Ser. No. 62/686,940, filed on Jun. 19, 2018, the disclosure of which is fully incorporated herein.

### BRIEF DESCRIPTION OF THE INVENTION

Field of the Invention—This invention relates to deer hunting assists. More particularly, it relates to devices and apparatus for assisting the hunter in drawing deer to his/her hunting location. It employs applying various scents to a tree or ground-mounted scent display apparatus as further described herein.

### SUMMARY OF THE DRAWINGS

Further features, objectives and advantages of the present invention, currently being marketed under the brand name BuckStik™, will be clearer in the following detailed description made with reference to the accompanying drawings in which:

FIG. 1 is a front plan view of one embodiment of ground-mounted apparatus according to this invention;

FIG. 2 is front plan view of one embodiment of tree-mounted apparatus according to this invention; and

FIG. 3 is a front plan view showing the three separate scent containers for use with the aforementioned apparatus.

### DETAILED DESCRIPTION OF PREFERRED EMBODIMENTS

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provide an interactive deer scent display apparatus A. That apparatus not only provides a visual attractant to deer, but also serves as a scent dispersal in the correct anatomical positioning to the respective communicative scent glands of deer. It allows a person to attract deer to a desired spot they choose by scent dispersion according to deer social behaviors.

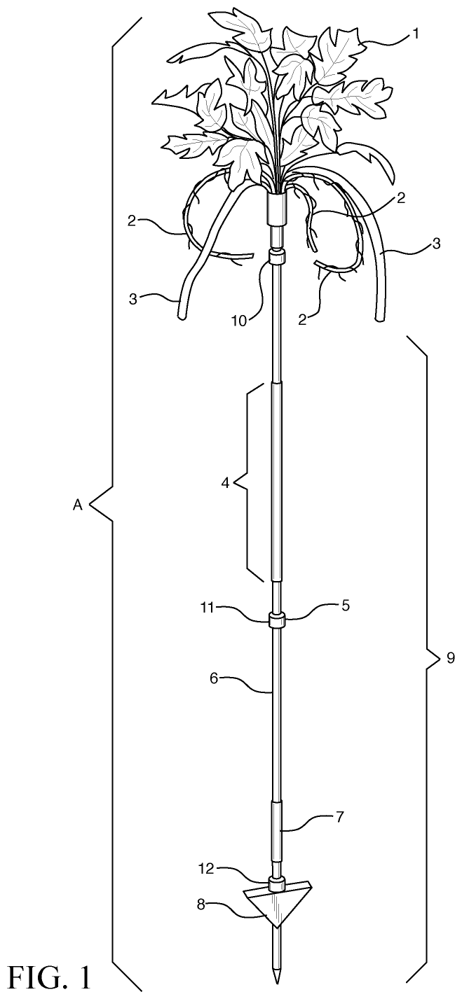

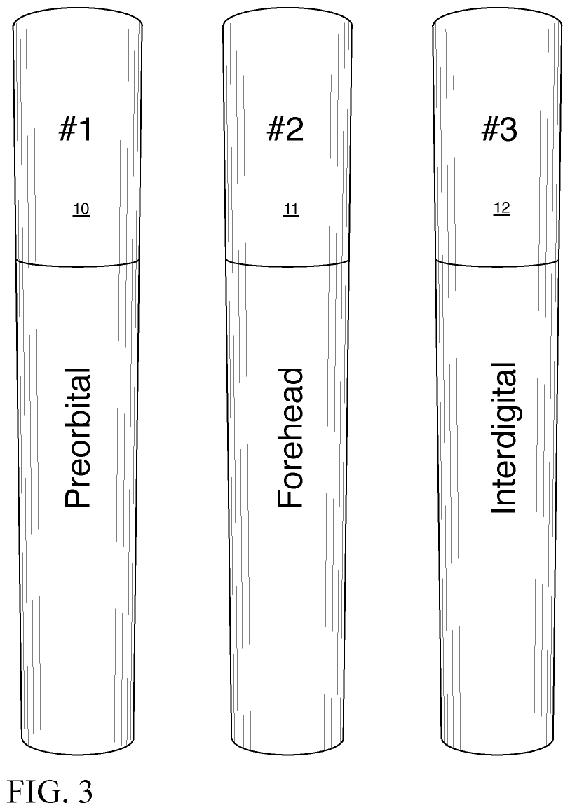

As seen in reference to FIG. 1, a non-limiting embodiment of ground-mounted apparatus A includes: an interactive leaf display 1, an interactive rope display 2; a pre-orbital scent gland pad (or vine) 3; an interactive, roughened strip display 4; a forehead scent gland pad 5; a first connecting ferrule 6; an inter-digital gland scent pad 7; a ground penetrating stake and stabilizer 8; and a flexible elongate rod 9. The scent gland pads 3, 5, and 7, and inter active displays 1, 2, and 4, are adapted to carry one of a plurality of natural or synthetic deer attractant scents, more particularly: a quantity of collected whitetail pre-orbital gland scent 10; a quantity of collected whitetail forehead gland scent 11; and a quantity of whitetail inter-digital gland scent 12. Containers with these same three, site-specific scents are shown in the respective bottles, 10 through 12, in FIG. 3.

The interactive leaf display 1 includes a plurality of silk synthetic leaves carried on a plurality of wire-reinforced, rough durable plastic stems and branches. The interactive rope display 2 may be formed by a plurality of cut lengths of organic coconut fiber ropes. The ends of the interactive leaf display and the interactive rope display are gathered and enclosed in a retainer that is coupled to a top end of flexible elongate rod 9.

The plurality of scent gland pads 3, 5, and 7, may be formed of a suitable absorbent material to carry plurality of scents. By way of non-limiting example, the scent pads 3, 5, 7 may be formed of a resilient porous foam material, felt, or other fabric. In some embodiments, the plurality of scent gland pads 2, 5, and 7, may also include a synthetic material impregnated with a desired scent. The pre-orbital scent pad 3 is disposed subjacent to the connector for the interactive leaf display 1 and rope display 2.

The interactive roughened strip display 4 may be formed by rough nylon woven strips secured around an upper section of the elongate rod 9, below the pre-orbital scent pad 3. As will be appreciated the rough center strip display 4 may also be integrally formed with the upper section of the elongate rod 9.

A forehead scent gland pad 5 is disposed along the elongate rod 9 at an intermediate section of the elongate rod, preferably below the interactive roughened strip display 4. For a collapsible elongate rod 9, a ferrule 6 may be included to join one or more segments of the elongate rod 9. In other embodiments, the elongate rod 9 may also have one or more foldable joints, or may also be formed in a telescoping configuration. Preferably the elongate rod 9 is formed of a lightweight flexible fiberglass tubular material.

The inter-digital scent pad 7, is disposed at a bottom end of the elongate rod 9, above a ground penetrating stake 8 end of the elongate rod 9. The ground-penetrating stake 8 may also include at least one flange extending from the side to provide a foot placement for urging the rod into the ground and stabilizing the display in a ground surface.

In the non-limiting embodiment shown, the (two-piece) elongate rod 9 is the main body of the display to which all the interactive parts are attached. The rod 9 may be a ⅜″ fiberglass rod that is flexible and allows the resistance and interaction deer look for in small saplings and trees. Attached at the top of the fiberglass rod 9 is the interactive top assembly 1, 2 and 3. The leaf assembly 1 is a visual attractant to deer and the fabric materials also collects and holds a deer's pre-orbital gland used for communication. The interactive ropes 2 are configured to collect and hold a deer's saliva and further the deer's communication with the herd. The pre-orbital scent pad 3 holds a quantity of the pre-orbital gland lure 10 and is positioned at anatomically correct eye level with the deer.

Between the center and top of the flexible rod 9 is an interactive, rough and woven, strip 4. This interactive roughened strip 4 provides the display with the correct “feel” for a deer to rub and interact with. When formed of a woven or porous material it allows the interactive strip 4 to collect and retain the interacting deer's forehead gland scent.

In the middle of the elongate rod 9 is a forehead scent pad 5 for holding a quantity of pure forehead gland scent attractant 11. Note how this scent pad is presented at the anatomically correct position natural to deer.

At the center of the fiberglass rod 9 is a ferrule 6 for connecting the two pieces of the rod. The ferrule 6 allows the rod 9 to be broken down into two pieces for easy breakdown and transport. Near the bottom of the fiberglass rod 9 is located the inter-digital scent pad 7, which is used for holding the pure inter-digital gland attractant 12. Being located proximal to ground level the inter-digital scent pad 7 is anatomically positioned with that of a deer's hooves. The steel bladed step-in (8) makes it simple and easy to insert fiberglass rod (9) into the ground while also adding some much needed stability.

By placing this invention in the ground, the hunter can choose any location near deer habitat, providing a suitable line of sight from a desired observation point. Applying the attractant scents to be disposed at the correct anatomical level, a hunter can attract deer to any location he chooses.

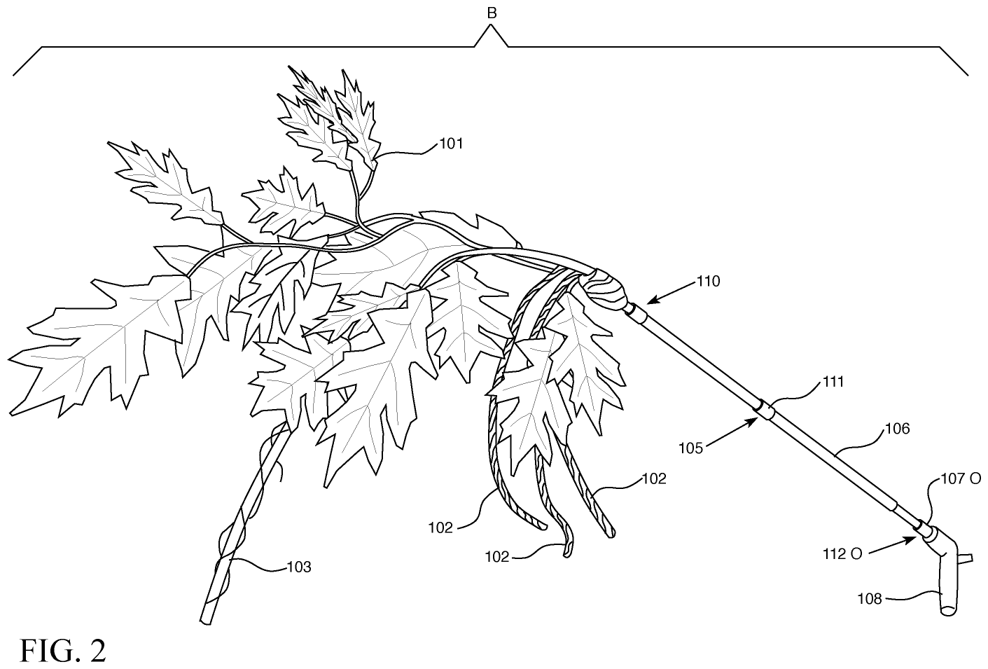

In the second variation of apparatus B, FIG. 2 shows a tree-mounted alternative. For this alternate embodiment, common elements with those in FIG. 1 are commonly numbered though in the next hundred series. As such, this version of tree-mounted apparatus B comprises: an interactive leaf display 101, an interactive rope display 102; a pre-orbital scent gland pad (or vine) 103 for holding a quantity of pre-orbital scent 110; an interactive, roughened strip display 104; a forehead scent gland pad 105 for holding a quantity of forehead scent 111; a first connecting ferrule 106 and a tree-mounted stabilizer bracket 108. Optionally, a base scent gland pad 107O may be positioned at or near the stabilizer bracket 108 (especially when positioned nearer the ground rather than higher up a given tree trunk) for optionally holding a quantity of whitetail inter-digital gland scent 112O.

### Instructions for Use

It is suggested that assembly of either apparatus (ground OR tree mount) be done in the field. First, assemble the two halves at the metal ferrule. Then, using one's foot, push the post into the ground with its easy step-in, until the base of the rod is flush with the ground. Next, arrange the top leaf assembly by spreading out its leaves. Finally, apply each of the glands as follows: the pre-orbital gland to the top leaf assembly and interactive ropes; the forehead gland to the middle, interactive forehead strip and the inter-digital glad to the bottom scent pad and surrounding ground.

It is not recommended to use this apparatus with any other product. Nor should the apparatus be placed near bait or mineral sites. Note that it takes very little pure gland to “prime” or activate the apparatus. In fact, too much gland could result in a negative reaction by deer on first approach. Try using one or two sprays only and refresh about every 2 to 3 weeks.

This invention uses a buck's own natural pheromones in a bio communication system/lure/attractant. Unlike urine-based lures, this invention taps into the very psyche of a buck's communication with his herd. By presenting three main glands for communicating through rubs and scrapes, this apparatus helps the buck establish territorial herd dominance.

It is best to use the aforementioned apparatus from August to September and into the stages of rut. Though bucks, does and fawns have been known to interact and communicate with the apparatus year round. During the off season (May-early August), the invention works well by itself just by situating the apparatus anywhere deer congregate including feeding areas, fields, tunnel crossings, etc. Using the device with a trail cam during the off season enables one to inventory the herd and keep tabs on up-and-coming bucks.

Pre-rut, active rut or post-rut, this invention works best as it is the most territorial time of the year. Testosterone spikes and this apparatus assists in telling those nearby that “a new guy's in town”. Ideally, one should situate his or her BuckStik™ near their stand about 48 hours before hunting . . . preferably about 20-25 yards away.

It should be understood, of course, that the foregoing relates to exemplary embodiments of the invention and that modifications may be made without departing from the spirit and scope of the invention as set forth herein.

What is claimed is:

1. A deer scent display apparatus comprising: (a) a leaf display component; (b) at least one of a rope display component and a vine display component; (c) an elongated stake suitable for mounting at a lower end of the elongated stake to a tree or into a ground location; (d) a pad onto which to administer a pre-orbital scent gland lure; and (e) a pad onto which to administer a forehead scent gland lure.

2. The deer scent display apparatus of claim 1, which further includes: (f) a pad onto which to administer an inter-digital gland lure.

3. The deer scent display apparatus of claim 2 wherein the inter-digital gland lure pad is located at or near the lower end of the elongated stake.

4. The deer scent display apparatus of claim 2 wherein the pre-orbital scent gland lure, the forehead scent gland lure and the inter-digital gland lure are natural.

5. The deer scent display apparatus of claim 2 wherein at least one of the pre-orbital scent gland lure, the forehead scent gland lure and the inter-digital gland lure are synthetic.

6. The deer scent display apparatus of claim 2, which further includes a roughened strip display against which deer may rub its head.

7. The deer scent display apparatus of claim 6 wherein the roughened strip display is located at or near a central point of the elongated stake.

8. The deer scent display apparatus of claim 6 wherein the roughened strip display is integrally formed with the elongated stake.

9. The deer scent display apparatus of claim 1 wherein the elongated stake is made in multiple sections that are joined together for assembly and use.

10. The deer scent display apparatus of claim 1 wherein the elongated stake is made in telescopic sections.

11. The deer scent display apparatus of claim 1 wherein the elongated stake is made from a flexible fiberglass material.

12. The deer scent display apparatus of claim 1, which further includes one or more flanges at the lower end of the elongated stake for assisting with installation into the ground location.

13. An interactive deer scent apparatus for displaying and collecting deer scent in correct anatomical positions, said apparatus comprising: (a) a leaf display component; (b) at least one of a rope display component and a vine display component; (c) an elongated stake suitable for mounting at a lower end of the elongated stake to a tree or into a ground location; (d) a roughened strip display against which deer may rub its head; (e) a pad onto which to administer a pre-orbital scent gland lure; (f) a pad onto which to administer a forehead scent gland lure; and (g) a pad onto which to administer an inter-digital gland lure.

14. The interactive deer scent display apparatus of claim 13 wherein the pre-orbital scent gland lure, the forehead scent gland lure and the inter-digital gland lure are natural.

15. The interactive deer scent display apparatus of claim 13 wherein the elongated stake is made in multiple sections that are joined together for assembly and use.

16. The interactive deer scent display apparatus of claim 13 wherein the elongated stake is made from a flexible fiberglass material.

17. The interactive deer scent display apparatus of claim 13, which further includes one or more flanges at the lower end of the elongated stake for assisting with installation into the ground location.

18. A method for attracting deer to a given external location comprises;
(a) providing an interactive deer scent apparatus comprising:
(i) a leaf display component;
(ii) at least one of a rope display component and a vine display component;
(iii) an elongated stake suitable for mounting at a lower end of the elongated stake into ground at the external location;
(iv) a roughened strip display against which deer may rub its head;
(v) a pad onto which to administer a pre-orbital scent gland lure;
(vi) a pad onto which to administer a forehead scent gland lure; and
(vii) a pad onto which to administer an inter-digital gland lure;
(b) installing the elongated stake of the apparatus into ground at the external location; and
(c) administering the pre-orbital scent gland lure, the forehead scent gland lure and inter-digital gland lure to their respective pads on the apparatus.

19. The method of claim 18 wherein the pre-orbital scent gland lure, the forehead scent gland lure and inter-digital gland lure are natural or synthetic.

20. The method of claim 18, which further includes:
(d) periodically applying additional gland lure to one or more of the pads on the apparatus.
